(19) United States
(12) Patent Application Publication
(10) Pub. No.: US 2024/0021887 A1
(43) Pub. Date: Jan. 18, 2024

(54) ELECTROLYTE FOR AQUEOUS ZINC-BROMINE BATTERY CONTAINING BROMINE COMPLEXING AGENT AND METAL ION ADDITIVE, AND AQUEOUS ZINC-BROMINE NON-FLOW BATTERY CONTAINING SAME

(71) Applicant: GWANGJU INSTITUTE OF SCIENCE AND TECHNOLOGY, Gwangju (KR)

(72) Inventors: Hyeong-Jin KIM, Gwangju (KR); Hyeonghun PARK, Gwangju (KR); Santosh KUMAR, Gwangju (KR); Geumyong PARK, Gwangju (KR); Hyunsu KIM, Gwangju (KR); Juyeon BAEK, Gwangju (KR); Seokho SUH, Gwangju (KR); Hocheol YOON, Gwangju (KR)

(21) Appl. No.: 18/215,815

(22) Filed: Jun. 28, 2023

(30) Foreign Application Priority Data
Jul. 13, 2022 (KR) 10-2022-0086525

(51) Int. Cl. H01M 10/36

(52) U.S. Cl. CPC H01M 10/365; H01M 2300/0002

(57) ABSTRACT

Provided is an electrolyte including a bromine complexing agent and a metal ion additive. The electrolyte is prepared by inputting zinc bromide (ZnBr₂) salt, a bromine complexing agent, and a metal ion additive containing Mn to DI water. The bromine complexing agent prevents a crossover phenomenon by capturing bromine to alleviate self-discharge at a positive electrode, and the metal ion additive inhibits the formation of zinc dendrites on a negative electrode through an electrostatic shielding effect. Accordingly, battery performance may be improved by a synergistic effect generated in a positive electrode and a negative electrode by the bromine complexing agent and the metal ion additive.

### CLAIM FOR PRIORITY

This application claims priority to Korean Patent Application No. 10-2022-0086525 filed on Jul. 13, 2022 in the Korean Intellectual Property Office (KIPO), the entire contents of which are hereby incorporated by reference.

### BACKGROUND

### 1. Technical Field

Example embodiments of the present inventive concept relates to an electrolyte for an aqueous battery and an aqueous battery including the same, and more particularly, to an electrolyte for an aqueous zinc-bromine battery, including a bromine complexing agent and a metal ion additive, and an aqueous zinc-bromine non-flow battery, including the same.

### 2. Related Art

As an alternative to environmental problems caused by the use of fossil fuel, research using renewable energies such as solar light and wind power is being conducted, but it is difficult to secure the stability of power supply because natural energy with high variability is used. Accordingly, a large-scale energy storage system (ESS) that can address unstable power supply and increase the efficiency of power consumption is attracting attention.

Currently, a lithium ion battery-based ESS with high energy efficiency is mainly used, but there is a risk of ignition because it uses a flammable organic electrolyte and a lithium-based material. Accordingly, a non-flammable aqueous battery, which uses water as an electrolyte that can block overheating and lower the risk of fire, is attracting attention as a next-generation ESS.

As a representative aqueous battery, there is a zinc-bromine redox battery. The zinc-bromine redox battery is inexpensive and has a high driving voltage and a high energy density. However, a crossover phenomenon in which the charged positive electrode active materials, Br₂ and Brⁿ⁻, diffuse to a negative electrode to react with Zn to generate a self-discharge reaction occurs. In addition, during charging, zinc ions are locally electrodeposited on a specific area on the surface of a zinc negative electrode and thus a dendrite is formed, decreasing the lifetime and efficiency of the battery. Accordingly, there is a need for a technology that can uniformly electrodeposit/release a metal to prevent a crossover phenomenon by fixing a positive electrode active material to an electrode and the dendrite formation of the zinc negative electrode.

### SUMMARY

Example embodiments of the present inventive concept provide an electrolyte for a zinc-bromine aqueous battery, which includes zinc bromide (ZnBr₂) salt, a bromine complexing agent and a metal ion additive.

Example embodiments of the present inventive concept also provide an aqueous zinc-bromine non-flow battery, which includes the electrolyte.

In some example embodiments, an electrolyte for a zinc-bromine aqueous battery, which includes ZnBr₂, a bromine complexing agent and a metal ion additive, is provided. A salt containing manganese, which is a metal ion that has a standard reduction potential of less than −0.76 V and a standard oxidation potential of more than 1.08 V, may be used as the metal ion additive.

In other example embodiments, an aqueous zinc-bromine non-flow battery in which the electrolyte described above is charged in a space between a positive electrode formed by disposing carbon graphite felt on a positive electrode conductive plate and a negative electrode formed by disposing a zinc metal layer on a negative electrode conductive plate is provided.

### BRIEF DESCRIPTION OF DRAWINGS

Example embodiments of the present inventive concept will become more apparent by describing in detail example embodiments of the present inventive concept with reference to the accompanying drawings, in which:

FIG. 1 is a cross-sectional view of a battery which includes an electrolyte containing a bromine complexing agent and a metal ion additive;

FIGS. 2A-2B are elevation views illustrating electrostatic shielding phenomena when a metal ion additive is not included and after including a metal ion additive;

FIGS. 3A-3B are graphs showing the standard redox potentials of metal ions and a graph for batteries using chromium as a metal ion additive;

FIG. 4 is a graph showing the coulombic efficiency of batteries including different types of metal ion additives;

FIG. 5 is a graph showing the coulombic efficiency of a battery including 1-ethylpyridinium bromide (1-EpBr) and/or MnSO₄ and a battery not including them;

FIGS. 6A-6B are a scanning electron microscopy (SEM) image after zinc is electrodeposited on the surface of a zinc negative electrode;

FIG. 7 is an X-ray photoelectron spectroscopy (XPS) graph after zinc is electrodeposited on the surface of a zinc negative electrode;

FIG. 8 is a graph of open circuit voltage curves of a battery including 1-EpBr and/or MnSO₄ and a battery not including them;

FIG. 9 is a graph that compares coulombic efficiency according to the concentration of MnSO₄ when 0.1 M 1-EpBr is input to an electrolyte;

FIG. 10 is a graph that compares voltage efficiency according to the concentration of MnSO₄ when 0.1 M 1-EpBr is input to an electrolyte;

FIG. 11 is a graph that compares coulombic efficiency according to the concentration of 1-EpBr; and

FIG. 12 is a graph that compares coulombic efficiency according to the concentration of MnSO₄ when 0.5 M 1-EpBr is input to an electrolyte.

### DESCRIPTION OF EXAMPLE EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments of the present inventive concept will be described in further detail with reference to the accompanying drawings.

### First Embodiment

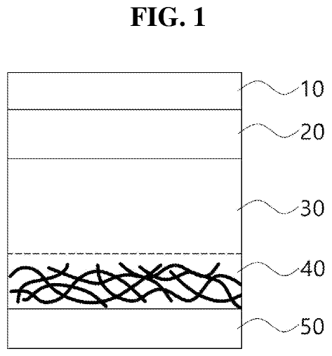

FIG. 1 is a cross-sectional view of a zinc-bromine aqueous battery, which includes an electrolyte containing zinc bromide (ZnBr₂) salt, a bromine complexing agent, and a metal ion additive. The battery is configured by forming a positive electrode by disposing carbon graphite felt 40 on a positive electrode conductive plate 50, forming a negative electrode by disposing a zinc metal layer 20 on a negative electrode conductive plate 10, placed on the other side, and injecting an electrolyte 30 into a space between the positive electrode and the negative electrode.

The bromine complexing agent is one or more selected from the group consisting of 1-ethylpyridinium bromide ([C₂Py]Br,1-EpBr), 1-methylpyrrolidin-1-ium hydrobromide ([HMP]Br), 1-ethyl-1-methylpyrrolidin-1-iumbromide ([C₂MP]Br)(=[MEP]Br), 1-n-butyl-1-methylpyrrolidin-1-iumbromide ([C₄MP]Br), 1-n-hexyl-1-methylpyrrolidin-1-iumbromide ([C₆MP]Br), 1-ethyl-1-methylmorpholin-1-iumbromide ([C₂MM]Br)(=[MEM]Br), 1-n-butyl-1-methylmorpholin-1-iumbromide ([C₄MM]Br), pyridin-1-ium hydrobromide ([HPy]Br), 1-n-butylpyridin-1-iumbromide ([C₄Py]Br), 1-n-butylpyridin-1-iumchloride ([C₄Py]Cl), 1-n-hexylpyridin-1-iumbromide ([C₆Py]Br), 1-n-hexylpyridin-1-iumchloride ([C₆Py]Cl), 4-methylpyridine hydrobromide ([H₄MPy]Br), 1-ethyl-4-methylpyridine hydrobromide ([C₂₄MPy]Br), 1-n-butyl-4-methylpyridine hydrobromide ([C₄₄MPy]Br), 1-n-hexyl-4-methylpyridine hydrobromide ([C₂₃MPy]Br), 3-methylpyridine hydrobromide ([H₃MPy]Br), 1-ethyl-3-methylpyridinebromide ([C₂₃MPy]Br), 1-n-butyl-3-methyl-pyridinebromide ([C₄₃MPy]Br), 1-n-hexyl-3-methyl-pyridinebromide ([C₆₃MPy]Br), 3-methylimidazol-1-ium hydrobromide ([HMIm]Br), 1-ethyl-3-methylimidazol-1-iumbromide ([C₂MIm]Br), 1-ethyl-3-methylimidazol-1-iumchloride ([C₂MIm]Cl), 1-n-propyl-3-methylimidazol-1-iumbromide ([C₃MIm]Br), 1-n-butyl-3-methyl-imidazol-1-iumbromide ([C₄MIm]Br), 1-n-butyl-3-methyl-imidazol-1-iumchloride ([C₄MIm]Cl), 1-n-hexyl-3-methylimidazol-1-iumbromide ([C₆MIm]Br), 1-n-hexyl-3-methylimidazol-1-iumchloride ([C₆MIm]Cl), 1-methylpiperidin hydrobromide ([HMPip]Br), 1-ethyl-1-methylpiperidinbromide ([C₂MPip]Br), 1-n-butyl-1-methylpiperidinbromide ([C₄MPip]Br), 1-n-hexyl-1-methylpiperidinbromide ([C₆MPip]Br), 1,1,1-trimethyl-1-n-tetradecylammoniumbromide ([MTA]Br), 1,1,1-trimethyl-1-n-hexadecylammoniumbromide ([CTA]Br), tetraethylammoniumbromide ([TEA]Br), tetra-n-butylammoniumbromide ([TBA]Br), tetra-n-octylammoniumbromide ([TOA]Br), tetra-n-octylammoniumchloride ([TOA]Cl), (polysorbate)ₙ-1R₁-2R₂-3R₃ imidazolium bromide, and (polysorbate)ₙ-1R₁-3R₃ imidazolium bromide, in which each of R1, R2 and R3 independently has a functional group with 1 to 4 carbon atoms. As the bromine complexing agent, 1-EpBr is preferably used. As the 1-EpBr forms a complex with bromine to allow bromine to remain in the carbon graphite felt 40, a crossover phenomenon in which bromine in an electrolyte moves to a negative electrode is inhibited without a membrane. Since the crossover phenomenon is inhibited, dendrite formation caused by the reaction of bromine and zinc and self-discharge may be prevented.

The bromine complexing agent may have a molarity of 0.1 to 1.5 M, preferably 0.1 to 1.0 M. The molarity of the bromine complexing agent is more preferably 0.1 to 0.6 M, and even more preferably 0.4 to 0.6 M. When the molarity is less than 0.1 M, bromine may not be properly captured, and when the molarity is more than 1.5 M, as the concentration increases, the ionic conductivity in the electrolyte decreases, and thus the bromine concentration in the electrolyte becomes excessively low. Accordingly, battery performance may not be good.

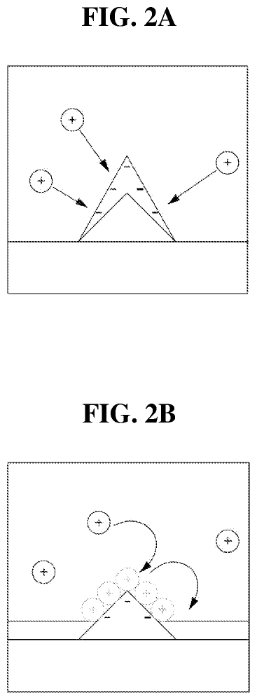

The metal ion additive may induce an electrostatic shielding phenomenon on the surface of a zinc electrode. FIG. 2 is an elevation view of the surface of a zinc electrode in batteries using an electrolyte not including a metal ion additive and an electrolyte including a metal ion additive. Referring to FIG. 2A, generally, Zn²⁺ generated during battery charging is electrodeposited on the surface protrusion of the zinc electrode, forming dendrites. However, in FIG. 2B using an electrolyte including the metal ion additive, Zn²⁺ is not electrodeposited on the surface protrusion of the zinc electrode. As the metal ion additive is bound with the surface protrusion of the zinc electrode to induce an electrostatic shielding effect, Zn²⁺ is not electrodeposited on the protrusion but uniformly electrodeposited on the surface around the protrusion, resulting in alleviating the formation of dendrites.

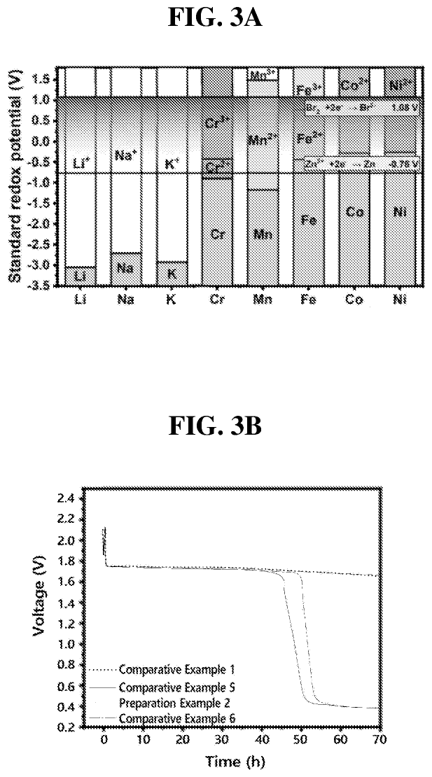

The metal ion additive preferably includes metal ions having a standard reduction potential of less than −0.76 V and a standard oxidation potential of more than 1.08 V. FIG. 3A shows a graph showing the standard redox potentials of metal ions to find a metal ion suitable for an additive, and FIG. 3B shows a graph obtained by evaluating the performance of a battery using chromium as a metal ion additive. The redox reactions of zinc and bromine are shown in Formula 1 below.

Br₂+2e⁻↔2Br⁻

Zn²⁺+2e⁻↔Zn [Formula 1]

The standard oxidation potential of bromine in Formula 1 is 1.08 V, and the standard reduction potential of zinc in Formula 1 is −0.76 V. Accordingly, the metal ions of the metal ion additive have to be materials that do not cause redox reactions at −0.76 V to 1.08 V to prevent a battery from reacting during battery operation. Metal ions satisfying the condition outside the range of −0.76 V to 1.08 V are lithium, sodium, potassium, and manganese. Although chromium is a metal ion having the same cycle as potassium and manganese, it is not suitable for use as a metal ion additive because it is reduced from Cr³⁺ to Cr²⁺ at approximately −0.407 V within the above range. When chromium is used as a metal ion additive, compared to the case in which only ZnBr₂ is used as an electrolyte, or 1-EpBr is additionally included, the voltage rapidly decreased after approximately 45 hours of discharging. Accordingly, it is difficult to use chromium as a metal ion additive because self-discharge is induced by a reaction of chromium in a battery over time and thus the voltage drops greatly.

The metal ion additive preferably includes Mn, and is one selected from the group consisting of MnSO₄, MnCl₂, Mn(NO₃)₂, Mn₃(PO₄)₂, and Mn(CH₃CO₂)₂. More preferably, as the metal ion additive, MnSO₄ is used. The standard reduction potential of Mn²⁺ is approximately −1.18 V, which is not included in the above range, and the standard oxidation potential of Mn²⁺ is approximately 1.4 V, which is not included in the above range. When a metal ion additive including manganese is used, compared to metal ion additives including lithium sodium and potassium, fewer dendrites are formed, and excellent coulombic efficiency is obtained up to 700 cycles.

The metal ion additive may have a molarity of 0.05 M to 0.1 M, preferably 0.05 M. When the molarity of the metal ion additive is less than 0.05 M or more than 0.1 M, the performance of the battery may not be excellent because the coulombic efficiency drops below 90%.

The molarity of ZnBr₂ may be 2.0 M to 3.0 M, and preferably 2.25 M to 2.8 M. When the molarity of ZnBr₂ is less than 2.0 M, it is disadvantageous in terms of energy density because the amount of an active material in the electrolyte is reduced. In addition, since the salt concentration in the electrolyte is lowered, ionic conductivity is lowered. When the molarity of ZnBr₂ exceeds 3.0 M, the pH of the electrolyte decreases, so a hydrogen evolution reaction (HER) becomes active. Accordingly, the pressure in a cell increases due to hydrogen generated in the cell, causing the problem of an insufficient electrolyte.

### Preparation Example 1

An electrolyte was prepared by inputting 2.25 M ZnBr₂, 0.1 M 1-EpBr and 0.5 M MnSO₄ to DI water and stirring the resulting solution for 1 hour.

### Preparation Example 2

An electrolyte was prepared by inputting 2.25 M ZnBr₂ and 0.1 M 1-EpBr to DI water and stirring the resulting solution for 1 hour.

### Preparation Example 3

An electrolyte was prepared by inputting 2.25 M ZnBr₂, 0.1 M 1-EpBr, and 0.05 M MnSO₄ to DI water and stirring the resulting solution for 1 hour.

### Preparation Example 4

An electrolyte was prepared by inputting 2.25 M ZnBr₂ and 0.05 M MnSO₄ to DI water and stirring the resulting solution for 1 hour.

### Preparation Example 5

An electrolyte was prepared by inputting 2.25 M ZnBr₂, 0.1 M 1-EpBr, and 0.1 M MnSO₄ to DI water and stirring the resulting solution for 1 hour.

### Preparation Example 6

An electrolyte was prepared by inputting 2.8 M ZnBr₂ and 0.1 M 1-EpBr to DI water and stirring the resulting solution for 1 hour.

### Preparation Example 7

An electrolyte was prepared by inputting 2.8 M ZnBr₂ and 0.2 M 1-EpBr to DI water and stirring the resulting solution for 1 hour.

### Preparation Example 8

An electrolyte was prepared by inputting 2.8 M ZnBr₂ and 0.3 M 1-EpBr to DI water and stirring the resulting solution for 1 hour.

### Preparation Example 9

An electrolyte was prepared by inputting 2.8 M ZnBr₂ and 0.4 M 1-EpBr to DI water and stirring the resulting solution for 1 hour.

### Preparation Example 10

An electrolyte was prepared by inputting 2.8 M ZnBr₂ and 0.5 M 1-EpBr to DI water and stirring the resulting solution for 1 hour.

### Preparation Example 11

An electrolyte was prepared by inputting 2.8 M ZnBr₂ and 0.6 M 1-EpBr to DI water and stirring the resulting solution for 1 hour.

### Preparation Example 12

An electrolyte was prepared by inputting 2.8 M ZnBr₂, 0.5 M 1-EpBr, and 0.05 M MnSO₄ to DI water and stirring the resulting solution for 1 hour.

### Preparation Example 13

An electrolyte was prepared by inputting 2.8 M ZnBr₂, 0.5 M 1-EpBr, and 0.1 M MnSO₄ to DI water and stirring the resulting solution for 1 hour.

### Preparation Example 14

An electrolyte was prepared by inputting 2.8 M ZnBr₂, 0.5 M 1-EpBr, and 0.2 M MnSO₄ to DI water and stirring the resulting solution for 1 hour.

### Comparative Example 1

An electrolyte was prepared by inputting 2.25 M ZnBr₂ to DI water and stirring the resulting solution for 1 hour.

### Comparative Example 2

An electrolyte was prepared by inputting 2.25 M ZnBr₂, 0.1 M 1-EpBr, and 0.025 M Na₂SO₄ to DI water and stirring the resulting solution for 1 hour.

### Comparative Example 3

An electrolyte was prepared by inputting 2.25 M ZnBr₂, 0.1 M 1-EpBr, and 0.025 M Li₂SO₄ to DI water and stirring the resulting solution for 1 hour.

### Comparative Example 4

An electrolyte was prepared by inputting 2.25 M ZnBr₂, 0.1 M 1-EpBr, and 0.025 M KaSO₄ to DI water and stirring the resulting solution for 1 hour.

### Comparative Example 5

An electrolyte was prepared by inputting 2.25 M ZnBr₂ and 0.05 M CrCl₃ to DI water and stirring the resulting solution for 1 hour.

### Comparative Example 6

An electrolyte was prepared by inputting 2.25 M ZnBr₂, 0.1 M 1-EpBr, and 0.05 M CrCl₃ to DI water and stirring the resulting solution for 1 hour.

### Experimental Example 1

Experiments were performed by preparing unit cells including electrolytes of Preparation Examples 1 to 14 and Comparative Examples 1 to 6, respectively. In the unit cell, a current collector was placed on the end plate, the positive electrode was placed on the current collector, a chamber including the electrolyte was placed on the positive electrode, and a negative electrode were disposed in a symmetrical structure based on the chamber and fastened. The positive electrode used herein is 4T graphite felt, and the negative electrode is 0.25 T Zn foil.

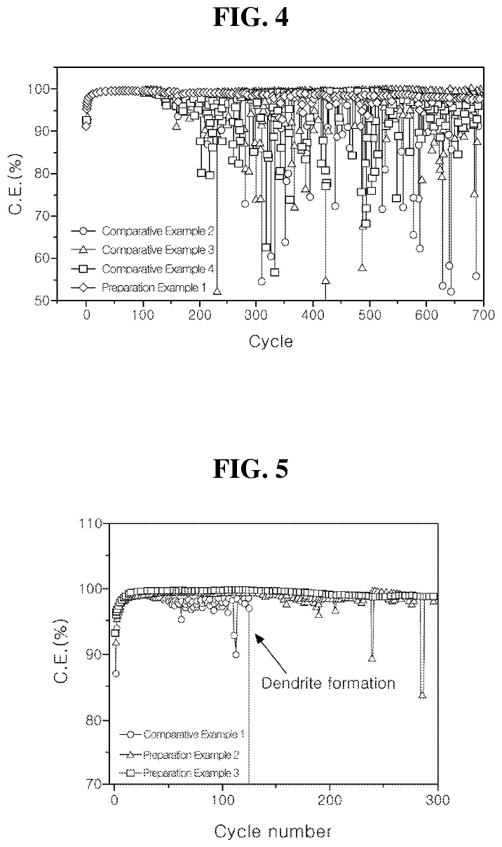

FIG. 4 is a graph showing the coulombic efficiency according to the cycle of a unit cell including different types of metal ion additives in 0.1 M 1-EpBr. An experiment was performed under conditions including a current density of 20 mAcm⁻², a charge capacity of 2 mAhcm⁻² and an active material concentration of 2.25 M ZnBr₂. It can be seen that, after 200 cycles, dendrites were formed as the coulombic efficiency of Comparative Examples 3 and 4 decreased. It was observed that the coulombic efficiency of Comparative Example 2 also rapidly decreased after 300 cycles. On the other hand, Preparation Example 1 using MnSO₄ as a metal ion additive maintained a coulombic efficiency of 90% or more up to 700 cycles. Therefore, it can be seen that the use of MnSO₄ as a metal ion additive is most efficient.

### Experimental Example 2

FIG. 5 is a graph showing the average coulombic efficiency of a unit cell including 2.25 M ZnBr₂ and a unit cell which includes or does not include MnSO₄ in 1-EpBr. An experiment was performed under conditions including a current density of 20 mAcm⁻² and a charge capacity of 2 mAhcm⁻².

TABLE 1

| | | Average coulombic |
|---|---|---|
| Classification | Electrolyte | efficiency |
| Comparative Example 1 | 2.25M ZnBr₂ | 88.1% |
| Preparation Example 2 | +0.1M 1-EpBr | 98.9% |
| Preparation Example 3 | +0.1M 1-EpBr | 99.4% |
| | +0.05M MnSO₄ | |

Table 1 shows the values of average coulombic efficiency according to the type of electrolyte. Comparative Example 1 which does not include 1-EpBr as a bromine complexing agent and MnSO₄ as a metal ion additive has an average coulombic efficiency of 88.1%, which is the lowest among Comparative Example 1, Preparation Example 2 and Preparation Example 3, and becomes irreversible due to dendrites formed at approximately 100 cycles. In contrast, Preparation Examples 2 and 3 maintain coulombic efficiency for 300 cycles or more, and exhibit excellent performance with an average coulombic efficiency of 98% or more. In Preparation Example 2 in which 1-EpBr as a bromine complexing agent is added, dendrites start to form after 200 cycles, resulting in a decrease in coulombic efficiency. However, in Preparation Example 3 in which MnSO₄ as a metal ion additive is added, MnSO₄ induces the electrodeposition and release of zinc to inhibit dendrite formation and prevent decreased coulombic efficiency, resulting in improving electrochemical performance.

### Experimental Example 3

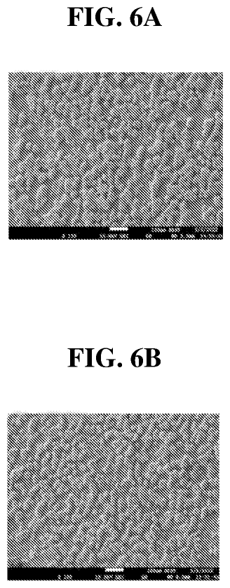

FIG. 6 is an SEM image after zinc electrodeposition under conditions of a current density of 20 mAcm⁻², a charge capacity of 5 mAhcm⁻² and an active material concentration of 2.25 M ZnBr₂ FIG. 6A is an SEM image of the zinc negative electrode of Preparation Example 2, in which zinc is formed large and loose. On the other hand, FIG. 6B is an SEM image of the zinc negative electrode of Preparation Example 3, in which zinc has a small size and is densely formed. This is because MnSO₄ as a metal ion additive included in Preparation Example 3 induces an electrostatic shielding effect. During charging of the unit cell, MnSO₄ is adsorbed on the surface protrusion of the zinc electrode in a cation type, preventing electrodeposition of zinc on the protrusion, and induces electrodeposition on a flat surface so that zinc is evenly electrodeposited on the surface. Accordingly, dendrite formation may be alleviated.

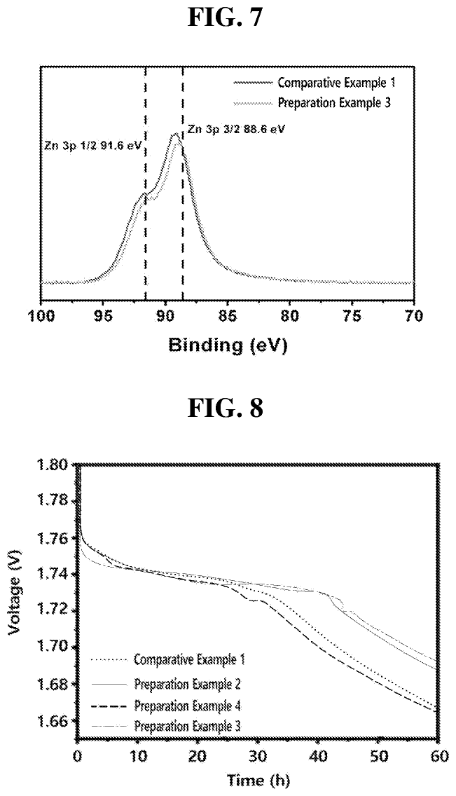

FIG. 7 is a graph of the XPS results for Comparative Example 1 and Preparation Example 3 after washing with water. In both Comparative Example 1 and Preparation Example 3, zinc peaks are observed at 88.6 eV and 91.6 eV. In Preparation Example 3, the reason why Mn²⁺ is not observed is that Mn²⁺ is adsorbed rather than completely chemically bonded with the protrusions on the surface of the zinc electrode. MnSO₄ is dissociated into Mn²⁺ in the form of a cation in the electrolyte and adsorbed on the protrusions on the surface of the zinc electrode by electrostatic attraction. Therefore, since it does not affect the zinc electrode, MnSO₄ does not react and remains stable during battery operation.

FIG. 8 shows an open circuit voltage curve, measured under conditions including a current density of 20 mAcm⁻², a charge capacity of 5 mAhcm⁻² and an active material concentration of 2.25 M ZnBr₂. Referring to FIG. 8, depending on the presence or absence of a bromine complexing agent, Comparative Example 1 and Preparation Example 4 show similar graphs to Preparation Example 2 and Preparation Example 3, respectively. In Comparative Example 1 and Preparation Example 4, which do not include a bromine complexing agent, the voltage rapidly drops over time, so the fluctuation range of the voltage is wide. In contrast, Preparation Examples 2 and 3, which include a bromine complexing agent, compared to Comparative Example 1, it has excellent electrochemical performance because the voltage gradually drops and the fluctuation range of the voltage is narrow. Accordingly, when an electrolyte including 1-EpBr as a bromine complexing agent is used, it can be seen that 1-EpBr may inhibit self-discharge by inhibiting the crossover phenomenon of bromine. In addition, while Comparative Example 1 and Preparation Example 2 do not include MnSO₄, since they show a graph pattern similar to Preparation Examples 3 and 4 using an electrolyte with the same conditions, except MnSO₄, it can be seen that MnSO₄ does not cause a reaction in the battery, and thus does not cause self-discharge. Accordingly, the use of the metal ion additive does not affect battery operation, and self-discharge may be inhibited by using the bromine complexing agent.

### Experimental Example 4

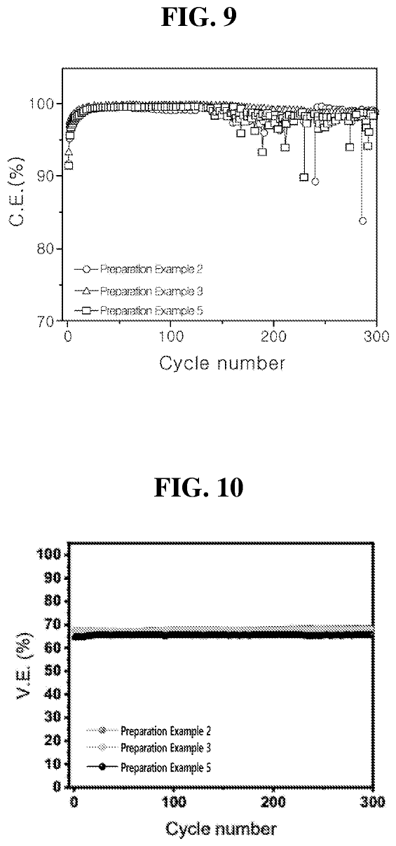

FIGS. 9 and 10 are graphs showing the optimization of MnSO₄ concentrations, obtained by measuring coulombic efficiency and voltage efficiency according to the number of cycles under conditions including a current density of 20 mAcm⁻², a charge capacity of 2 mAhcm⁻² and an active material concentration of 2.25 M ZnBr₂. The results are shown in Table 2 below.

TABLE 2

| | | Average | Average |
|---|---|---|---|
| | | coulombic | voltage |
| Classification | Electrolyte | efficiency | efficiency |
| Preparation Example 2 | +0.1M 1-EpBr | 98.9% | 67.7% |
| Preparation Example 3 | +0.1M 1-EpBr | 99.4% | 67.4% |
| | +0.05M MnSO₄ | | |
| Preparation Example 5 | +0.1M 1-EpBr | 98.7% | 65.5% |
| | +0.1M MnSO₄ | | |

Referring to FIG. 9, after approximately 150 cycles or more of charging/discharging, in Preparation Examples 2 and 5, dendrites were formed, decreasing coulombic efficiency. In contrast, in Preparation Example 3, dendrites were not formed up to 300 cycles, maintaining coulombic efficiency. Accordingly, when 0.05 M MnSO₄ as a metal ion additive is added as in Preparation Example 3, coulombic efficiency is the highest at 99.4%.

Referring to FIG. 10, the voltage efficiencies in Preparation Examples 2 and 3 were similar at approximately 67%, and the voltage efficiency in Preparation Example 5 was relatively low at 65.5%. In Preparation Example 5 in which 0.1 M MnSO₄ is added, due to an electrostatic repulsive force, an excessive effect of metal ion additive was exhibited, and low coulombic efficiency and voltage efficiency were measured. Accordingly, it is preferable that a battery using an electrolyte containing 2.25 M ZnBr₂ as an active material includes 0.05 M MnSO₄ as a metal ion additive because high coulombic efficiency and high voltage efficiency are obtained.

### Experimental Example 5

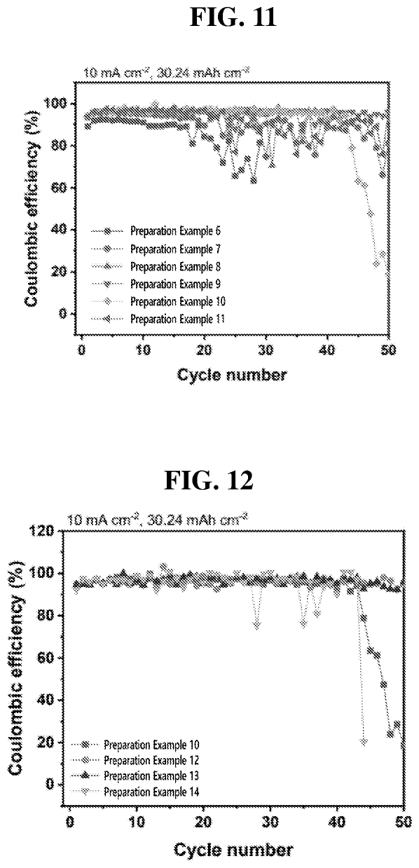

FIG. 11 is a graph measuring coulombic efficiency according to the concentration of 1-EpBr as a bromine complexing agent under conditions including a current density of 10 mAcm⁻², a charge capacity of 30.24 mAhcm⁻², and 2.8 M ZnBr₂ as an active material concentration. Preparation Examples 6 to 11 were evaluated by increasing the 1-EpBr concentration by 0.1 M from 0.1 M 1-EpBr in Preparation Example 6. Table 3 below shows average coulombic efficiency for each Preparation Example.

TABLE 3

| | | Average coulombic |
|---|---|---|
| Classification | Electrolyte | efficiency |
| Preparation Example 6 | +0.1M 1-EpBr | 88.1% |
| Preparation Example 7 | +0.2M 1-EpBr | 91.4% |
| Preparation Example 8 | +0.3M 1-EpBr | 94.5% |
| Preparation Example 9 | +0.4M 1-EpBr | 96.12% |
| Preparation Example 10 | +0.5M 1-EpBr | 96.38% |
| Preparation Example 11 | +0.6M 1-EpBr | 92.3% |

Referring to Table 3, the coulombic efficiency of Preparation Example 10 is the highest at 96.38%. Accordingly, a preferable 1-EpBr concentration according to the average coulombic efficiency is 0.1 M to 0.6 M. However, when 1-EpBr is used alone, referring to FIG. 11, Preparation Example 10 showed consistently excellent coulombic efficiency up to approximately 40 cycles, but thereafter, as the cycle was repeated, dendrites were formed, resulting in a deterioration in performance.

### Experimental Example 6

FIG. 12 is a graph measuring coulombic efficiency according to the concentration of MnSO₄ as a metal ion additive under conditions including a current density of 10 mAcm⁻², a charge capacity of 30.24 mAhcm⁻², 2.8 M ZnBr₂ as an active material concentration, and 0.5 M 1-EpBr as a bromine complexing agent with the highest average coulombic efficiency. Table 4 below shows the coulombic efficiency for each Preparation Example based on 50 cycles.

TABLE 4

| | | Coulombic efficiency |
|---|---|---|
| Classification | Electrolyte | (based on 50 cycles) |
| Preparation Example 10 | +0.5M 1-EpBr | 89.2% |
| Preparation Example 12 | +0.5M 1-EpBr | 96.3% |
| | +0.05M MnSO₄ | |
| Preparation Example 13 | +0.5M 1-EpBr | 96.4% |
| | +0.1M MnSO₄ | |
| Preparation Example 14 | +0.5M 1-EpBr | 94.0% |
| | +0.2M MnSO₄ | |

Referring to Table 4, MnSO₄ has a coulombic efficiency of 90% or more in Preparation Examples 12 and 13. Compared to Experimental Example 4, as the current density decreases from 20 mAcm⁻² to 10 mAcm⁻², and the electrostatic repulsion force decreases, and thus in Preparation Example 13 including 0.1 M MnSO₄, excellent coulombic efficiency is shown. In addition, referring to FIG. 12, in Experimental Example 5, when 0.5 M 1-EpBr showing the highest average coulombic efficiency was used together with 0.05 M MnSO₄ or 0.1 M MnSO₄, since MnSO₄ prevents dendrite formation, the problem of decreased performance generated after approximately 40 cycles was solved.

Accordingly, under the above conditions, the optimal concentration range of MnSO₄ in an electrolyte is 0.05 M to 0.1 M, and the performance of Preparation Example 13 is the highest.

As the present inventive concept uses a metal ion additive, an electrostatic shielding phenomenon may occur in a positive electrode to induce uniform electrodeposition/release of zinc, thereby inhibiting the growth of dendrites. Accordingly, reversibility is secured and thus electrochemical performance is improved. By using a metal ion additive with a higher standard reduction potential than that of zinc and a lower standard oxidation potential than that of bromine, the metal ion may not react during battery operation, resulting in maintenance of battery performance.

The present inventive concept may prevent a crossover phenomenon of bromine using a bromine complexing agent, and thus bock a reaction with zinc as a negative electrode active material. Due to this, dendrite formation may be inhibited, and as a result, self-discharge of the electrolyte may be inhibited during charging.

Since the present inventive concept provides an aqueous non-flow zinc-bromine battery, there is no need to use an additional electrolyte tank, so the problem of pipe corrosion may not occur.

In the present inventive concept, as a commercially-available metal ion additive and bromine complexing agent are added to an electrolyte, and a membrane and a tank are not used, a manufacturing process may be simplified, and production costs may be reduced.

Example embodiments of the present inventive concept can inhibit dendrite growth by inducing uniform electrodeposition/release of zinc due to an electrostatic shielding phenomenon occurring at a negative electrode by using a metal ion additive. Accordingly, reversibility is secured to improve electrochemical performance. In addition, by using a metal ion additive which has a higher standard reduction potential than that of zinc and a lower standard oxidation potential than that of bromine, the metal ions do not react during battery operation, so battery performance can be maintained.

Example embodiments of the present inventive concept can prevent a crossover phenomenon of bromine using a bromine complexing agent without a membrane, preventing a reaction with zinc, which is a negative electrode active material. Accordingly, coulombic efficiency can be increased by inhibiting dendrite formation, resulting in inhibition of self-discharge of the electrolyte during charging.

Example embodiments of the present inventive concept relate to an aqueous non-flow zinc-bromine battery, and thus, there is no need to additionally use an electrolyte tank, so the problem of piping corrosion does not occur.

Example embodiments of the present inventive concept can simplify a manufacturing process and reduce costs by inputting a commercially-available metal ion additive and bromine complexing agent to an electrolyte without using a membrane and a tank.

What is claimed is:

1. An electrolyte for a zinc-bromine aqueous battery, comprising:
zinc bromide (ZnBr₂) salt, a bromine complexing agent, and a metal ion additive.

2. The electrolyte of claim 1, wherein the bromine complexing agent is one or more selected from the group consisting of 1-ethylpyridinium bromide ([C₂Py]Br,1-EpBr), 1-methylpyrrolidin-1-ium hydrobromide ([HMP]Br), 1-ethyl-1-methylpyrrolidin-1-iumbromide ([C₂MP]Br)(=[MEP]Br), 1-n-butyl-1-methylpyrrolidin-1-iumbromide ([C₄MP]Br), 1-n-hexyl-1-methylpyrrolidin-1-iumbromide ([C₆MP]Br), 1-ethyl-1-methylmorpholin-1-iumbromide ([C₂MM]Br)(=[MEM]Br), 1-n-butyl-1-methylmorpholin-1-iumbromide ([C₄MM]Br), pyridin-1-ium hydrobromide ([HPy]Br), 1-n-butylpyridin-1-iumbromide ([C₄Py]Br), 1-n-butylpyridin-1-iumchloride ([C₄Py]Cl), 1-n-hexylpyridin-1-iumbromide ([C₆Py]Br), 1-n-hexylpyridin-1-iumchloride ([C₆Py]Cl), 4-methylpyridine hydrobromide ([H₄MPy]Br), 1-ethyl-4-methylpyridine hydrobromide ([C₂₄MPy]Br), 1-n-butyl-4-methylpyridine hydrobromide ([C₄₄MPy]Br), 1-n-hexyl-4-methylpyridine hydrobromide ([C₂₃MPy]Br), 3-methylpyridine hydrobromide ([H₃MPy]Br), 1-ethyl-3-methylpyridinebromide ([C₂₃MPy]Br), 1-n-butyl-3-methyl-pyridinebromide ([C₄₃MPy]Br), 1-n-hexyl-3-methyl-pyridinebromide ([C₆₃MPy]Br), 3-methylimidazol-1-ium hydrobromide ([HMIm]Br), 1-ethyl-3-methylimidazol-1-iumbromide ([C₂MIm]Br), 1-ethyl-3-methylimidazol-1-iumchloride ([C₂MIm]Cl), 1-n-propyl-3-methylimidazol-1-iumbromide ([C₃MIm]Br), 1-n-butyl-3-methyl-imidazol-1-iumbromide ([C₄MIm]Br), 1-n-butyl-3-methyl-imidazol-1-iumchloride ([C₄MIm]Cl), 1-n-hexyl-3-methylimidazol-1-iumbromide ([C₆MIm]Br), 1-n-hexyl-3-methylimidazol-1-iumchloride ([C₆MIm]Cl), 1-methylpiperidin hydrobromide ([HMPip]Br), 1-ethyl-1-methylpiperidinbromide ([C₂MPip]Br), 1-n-butyl-1-methylpiperidinbromide ([C₄MPip]Br), 1-n-hexyl-1-methylpiperidinbromide ([C₆MPip]Br), 1,1,1-trimethyl-1-n-tetradecyl ammoniumbromide ([MTA]Br), 1,1,1-trimethyl-1-n-hexadecyl ammoniumbromide ([CTA]Br), tetraethylammoniumbromide ([TEA]Br), tetra-n-butylammoniumbromide ([TBA]Br), tetra-n-octylammoniumbromide ([TOA]Br), tetra-n-octylammoniumchloride ([TOA]Cl), (polysorbate)ₙ-1R₁-2R₂-3R₃ imidazolium bromide, and (polysorbate)ₙ-1R₁-3R₃ imidazolium bromide,
wherein each of R1, R2 and R3 independently has a functional group with 1 to 4 carbon atoms.

3. The electrolyte of claim 1, wherein the bromine complexing agent has a molarity of 0.1 M to 1.5 M.

4. The electrolyte of claim 1, wherein the metal ion additive has a lower standard reduction potential than the standard reduction potential of zinc, and a higher standard oxidation potential than the standard oxidation potential of bromine.

5. The electrolyte of claim 1, wherein the metal ion additive is a salt containing Mn.

6. The electrolyte of claim 5, wherein the metal ion additive is one selected from the group consisting of MnSO₄, MnCl₂, Mn(NO₃)₂, Mn₃(PO₄)₂, and Mn(CH₃CO₂)₂.

7. The electrolyte of claim 1, wherein the metal ion additive has a molarity of 0.05 M to 0.1 M.

8. The electrolyte of claim 1, wherein the ZnBr₂ has a molarity of 2.0 M to 3.0 M.

9. An aqueous zinc-bromine non-flow battery, comprising:
a negative electrode in which a zinc metal layer is formed on a negative electrode conductive plate and zinc reduction occurs during a charging operation;
a positive electrode in which carbon felt is formed on a positive electrode conductive plate and bromine oxidation occurs during a charging operation; and
an electrolyte charged in a space between the negative electrode and the positive electrode,
wherein the electrolyte comprises ZnBr₂, a bromine complexing agent, and a metal ion additive.

10. The battery of claim 9, wherein the positive electrode comprises bromine captured on the carbon graphite felt by the bromine complexing agent during the charging operation.

11. The battery of claim 9, wherein the bromine complexing agent is one or more selected from the group consisting of 1-ethylpyridinium bromide ([C₂Py]Br,1-EpBr), 1-methylpyrrolidin-1-ium hydrobromide ([HMP]Br), 1-ethyl-1-methylpyrrolidin-1-iumbromide ([C₂MP]Br)(=[MEP]Br), 1-n-butyl-1-methylpyrrolidin-1-iumbromide ([C₄MP]Br), 1-n-hexyl-1-methylpyrrolidin-1-iumbromide ([C₆MP]Br), 1-ethyl-1-methylmorpholin-1-iumbromide ([C₂MM]Br)(=[MEM]Br), 1-n-butyl-1-methylmorpholin-1-iumbromide ([C₄MM]Br), pyridin-1-ium hydrobromide ([HPy]Br), 1-n-butylpyridin-1-iumbromide ([C₄Py]Br), 1-n-butylpyridin-1-iumchloride ([C₄Py]Cl), 1-n-hexylpyridin-1-iumbromide ([C₆Py]Br), 1-n-hexylpyridin-1-iumchloride ([C₆Py]Cl), 4-methylpyridine hydrobromide ([H₄MPy]Br), 1-ethyl-4-methylpyridine hydrobromide ([C₂₄MPy]Br), 1-n-butyl-4-methylpyridine hydrobromide ([C₄₄MPy]Br), 1-n-hexyl-4-methylpyridine hydrobromide ([C₂₃MPy]Br), 3-methylpyridine hydrobromide ([H₃MPy]Br), 1-ethyl-3-methylpyridinebromide ([C₂₃MPy]Br), 1-n-butyl-3-methyl-pyridinebromide ([C₄₃MPy]Br), 1-n-hexyl-3-methyl-pyridinebromide ([C₆₃MPy]Br), 3-methylimidazol-1-ium hydrobromide ([HMIm]Br), 1-ethyl-3-methylimidazol-1-iumbromide ([C₂MIm]Br), 1-ethyl-3-methylimidazol-1-iumchloride ([C₂MIm]Cl), 1-n-propyl-3-methylimidazol-1-iumbromide ([C₃MIm]Br), 1-n-butyl-3-methyl-imidazol-1-iumbromide ([C₄MIm]Br), 1-n-butyl-3-methyl-imidazol-1-iumchloride ([C₄MIm]Cl), 1-n-hexyl-3-methylimidazol-1-iumbromide ([C₆MIm]Br), 1-n-hexyl-3-methylimidazol-1-iumchloride ([C₆MIm]Cl), 1-methylpiperidin hydrobromide ([HMPip]Br), 1-ethyl-1-methylpiperidinbromide ([C₂MPip]Br), 1-n-butyl-1-methylpiperidinbromide ([C₄MPip]Br), 1-n-hexyl-1-methylpiperidinbromide ([C₆MPip]Br), 1,1,1-trimethyl-1-n-tetradecyl ammoniumbromide ([MTA]Br), 1,1,1-trimethyl-1-n-hexadecyl ammoniumbromide ([CTA]Br), tetraethylammoniumbromide ([TEA]Br), tetra-n-butylammoniumbromide ([TBA]Br), tetra-n-octylammoniumbromide ([TOA]Br), tetra-n-octylammoniumchloride ([TOA]Cl), (polysorbate)ₙ-1R₁-2R₂-3R₃ imidazolium bromide, and (polysorbate)ₙ-1R₁-3R₃ imidazolium bromide,
wherein each of R1, R2 and R3 independently has a functional group with 1 to 4 carbon atoms.

12. The battery of claim 9, wherein the negative electrode inhibits zinc dendrite formation by capping the surface of a surface protrusion of a zinc metal layer with the metal ion additive.

13. The battery of claim 9, wherein the metal ion additive has a lower standard reduction potential than the standard reduction potential of zinc, and a higher standard oxidation potential than the standard oxidation potential of bromine.

14. The battery of claim 9, wherein the metal ion additive is a salt containing Mn.

15. The battery of claim 9, wherein the metal ion additive is one selected from the group consisting of MnSO₄, MnCl₂, Mn(NO₃)₂, Mn₃(PO₄)₂, and Mn(CH₃CO₂)₂.
